(19) United States
(12) Patent Application Publication
(10) Pub. No.: US 2025/0205838 A1
(43) Pub. Date: Jun. 26, 2025

(54) PROCESSING STATION FOR WORKPIECES THAT ARE IN THE FORM OF VEHICLE BODY PARTS AND HAVE STORED, EXCHANGEABLE CLAMPING DEVICES, AND METHOD FOR CHANGING THE CLAMPING DEVICES

(71) Applicants: thyssenkrupp Automotive Body Solutions GmbH, Heilbronn (DE); thyssenkrupp AG, Essen (DE)

(72) Inventor: Tino KIPPING, Schmelz (DE)

(73) Assignees: thyssenkrupp Automotive Body Solutions GmbH, Heilbronn (DE); thyssenkrupp AG, Essen (DE)

(21) Appl. No.: 18/844,324

(22) PCT Filed: Mar. 8, 2023
(86) PCT No.: PCT/EP2023/055901

§ 371 Date: Sep. 5, 2024

(30) Foreign Application Priority Data
Mar. 9, 2022 (DE) 10 2022 202 356.0

(51) Int. Cl. B23P 21/00; B62D 65/18

(52) U.S. Cl. CPC B23P 21/004; B62D 65/18

(57) ABSTRACT

A processing station for workpieces which are configured as vehicle body parts comprises a plurality of carrier elements, a magazine with a plurality of magazine levels for providing the carrier elements, a work region for processing the workpieces, a first transport apparatus for transporting the carrier elements between the work region and a provision point of the magazine, a second transport apparatus for transporting the carrier elements in the magazine in the first magazine level in a transverse direction, and a third transport apparatus for transporting the carrier elements in a vertical direction between the magazine levels, the third transport apparatus having lifting elements which can be adjusted in the vertical direction for front-side receiving of the carrier elements, and the lifting elements comprising a fourth transport apparatus for transporting the carrier elements in a magazine level outside the first level in a transverse direction. Corresponding methods include changing the carrier elements between the work region and a position in the magazine.

The invention relates to a processing station for workpieces which are configured as vehicle body parts. The processing station comprises a plurality of carrier elements, a magazine for providing the carrier elements, the magazine having a first magazine level in a first level, a work region for processing workpieces in the first level, a first transport apparatus for transporting the carrier elements between the work region and a provision point of the magazine in the first magazine level in a longitudinal direction, and a second transport apparatus for transporting the carrier elements in the magazine in the first magazine level in a transverse direction.

Furthermore, the invention relates to a method for transporting a carrier element from a starting position within the magazine of the processing station into the work region of the processing station, and to a method for transporting a carrier element from the work region of the processing station into a target position within the magazine of the processing station.

Processing stations of this type are known, the carrier elements comprising, in particular, clamping apparatuses, further particularly clamping frames, by way of which the workpieces, in particular the vehicle body components, are positioned for the processing. The vehicle body parts which are positioned by means of the clamping apparatuses can then be connected irreversibly at the processing station, for example by way of a joining operation, it being possible for, in particular, welding, adhesive bonding, riveting or else clinching to be provided as joining operation. A clamping frame which is frequently used as a clamping apparatus is configured as a supporting frame which is as far as possible flat and on which a plurality of actuable clamps are held, via which the vehicle body parts are braced against one another at predefined points, in order to be joined there. A clamping frame per se is not configured to support and to transport a vehicle body part, but merely to bring a vehicle body component into a final, structurally predefined geometry.

In order for it to be possible for different vehicle body components to be processed by way of a processing station, for example vehicle body components which differ from one another in the case of different vehicle body shapes of a vehicle models such as coupe and sedan, it is known, for example, from EP 3 490 877 B1 that the processing stations have a plurality of clamping apparatuses which are provided in a magazine region of the processing station. If required, these clamping apparatuses are then moved by means of transport apparatuses of the processing station from the magazine region into the work region or from the work region into the magazine region.

It is a disadvantage in the case of the processing station according to EP 3 490 877 B1 that the area requirement for the processing station also increases with the number of clamping apparatuses to be provided, since a further magazine region is to be provided for each further clamping apparatus. This increase in the area requirement is frequently undesired, however.

Proceeding from this, it is therefore an object of the present invention to improve the processing station, advantageously in such a way that the number of vehicle body components which can be processed is increased with a substantially unchanged area requirement.

In order to achieve this object, a processing station and methods in accordance with the independent claims are proposed. Further advantageous refinements of the invention are described in the dependent claims and the description and are shown in the figures.

The proposed solution provides a processing station for workpieces which are configured as vehicle body parts, which processing station comprises a plurality of carrier elements, in particular a plurality of carrier elements for clamping apparatuses, and a magazine for providing the carrier elements, the magazine comprising a first magazine level in a first level and at least one further magazine level outside the first level, in particular above the first level and/or below the first level. In the first level, the processing station additionally has a work region for processing workpieces, in particular for processing vehicle body components which are braced against one another at predefined points by means of a clamping apparatus of a carrier element. Furthermore, the processing station comprises a first transport apparatus for transporting the carrier elements between the work region and a provision point of the magazine in the first magazine level in a longitudinal direction, a second transport apparatus for transporting the carrier elements in the magazine in the first magazine level in a transverse direction, and a third transport apparatus for transporting the carrier elements in a vertical direction between the magazine levels, the third transport apparatus having, lying opposite one another, in each case one lifting element which is adjustable in the vertical direction for front-side receiving of the carrier elements, and the lifting elements comprising a fourth transport apparatus for transporting the carrier elements in a magazine level outside the first level in a transverse direction. The lifting elements are therefore advantageously used not only for transporting the carrier elements in the vertical direction, but rather are also provided, in particular, for transporting the carrier elements in the transverse direction in the further magazine levels. By virtue of the fact that the magazine of the processing apparatus has a plurality of magazine levels which lie above one another, more carrier elements and therefore more clamping apparatuses can advantageously be provided in the processing station with a substantially unchanged area requirement. Here, the carrier elements, in particular the finally equipped carrier elements, are advantageously all different and are advantageously adapted for different vehicle body components.

The transport apparatuses of the processing station can advantageously be controlled in such a way, in particular can be controlled by means of an electronic control unit of the processing station in such a way, that the carrier elements can be changed, in particular can be changed in an automated manner, by means of the transport apparatuses between a storage position in the magazine of the processing station and the work region of the processing station. With regard to a simple exchange of a carrier element which is arranged in the work region of the processing station and a carrier element which is provided in the magazine, in particular an exchange without intermediate positioning of other carrier elements, it is advantageous if at most two carrier elements are provided in a magazine level, in particular in each case one carrier element on the right and on the left of the third transport apparatus. Furthermore, it is advantageous if only one carrier element is provided in the first magazine level. A further providing position in the first magazine level is then advantageously specified as avoidance position. By means of this avoidance position, carrier elements which are to be exchanged can advantageously be guided past one another. In addition, the lifting elements which have transported a carrier element from a magazine level outside the first level into the first level can be moved by means of the avoidance position out of the adjustment path in the longitudinal direction by the carrier element being moved into the avoidance position to this end.

It is provided, in particular, that the further magazine levels of the magazine are arranged above the first magazine level. It is also conceivable, however, that, in the case of a refinement with an underfloor solution, further magazine levels are arranged below the first magazine level, which makes further adaptations to the processing station necessary, however.

In accordance with one advantageous refinement of the processing station, the fourth transport apparatus comprises at least one drive arrangement with a toothed rack which can be moved in the transverse direction, the toothed rack advantageously having a driver element for coupling to a coupling element of the respective carrier element, and it being possible by way of a movement of the toothed rack for a coupled carrier element to be transported in the magazine level outside the first level in a transverse direction. The drive arrangement advantageously comprises a drivable pinion which acts on the toothed rack. Furthermore, it is advantageously provided that the drive arrangement of the fourth transport apparatus comprises a rail arrangement which comprises, in particular, two U-profiles, the openings of which face one another. Here, running rollers with rotational axes which extend in the longitudinal direction are advantageously arranged on the sides of the toothed rack of the drive arrangement, the U-profiles providing the running surfaces for the running rollers when the toothed rack is moved in the transverse direction. It can be provided, in particular, for supporting rollers with rotational axes which extend in the vertical direction to be arranged in addition to the running rollers on the sides of the toothed rack, which support rollers can be supported against the U-profile and therefore advantageously prevent oblique positioning of the toothed rack. The driver elements of the toothed rack are advantageously arranged in each case at the ends of the toothed rack. The length of the toothed rack advantageously corresponds to the length of the U-profiles. In particular, the length of the toothed rack corresponds substantially to the length of the lifting element.

The driver element is advantageously configured such that it can be adjusted between a coupling position and a decoupling position. As an alternative or in addition, the coupling element is advantageously configured such that it can be adjusted between a coupling position and a decoupling position. It is provided, in particular, that the driver element is configured as an adjustable pin, in particular a pneumatically adjustable pin, which can be moved from the decoupling position into the coupling position, in particular in order to establish an operative connection to the coupling element which is configured, in particular, as a receiving opening or as a receiving bush. In order to disconnect this operative connection, the driver element can be moved from the coupling position into the decoupling position.

In accordance with a further advantageous refinement, the at least one drive arrangement of the fourth transport apparatus comprises in each case one drive unit, the drive unit being arranged on the lifting element. In particular, an electric motor is provided as drive unit, the electric motor advantageously being arranged on the lifting element. It is provided, in particular, that the drivable pinion is arranged on a motor shaft of the electric motor.

Each of the lifting elements preferably has in each case one drive arrangement of the fourth transport apparatus. That is to say, each of the lifting elements advantageously comprises a toothed rack which can be moved in the transverse direction, the toothed rack advantageously having a driver element for coupling to a coupling element of a respective carrier element, and it being possible for a coupled carrier element to be transported in a magazine level outside the first level in a transverse direction by way of a movement of the toothed rack. Here, the toothed racks of the lifting elements are advantageously moved synchronously.

A further advantageous refinement provides that the further magazine levels of the magazine of the processing station comprise in each case one rail arrangement with running surface portions which run in the transverse direction. In addition, it is provided, in particular, that the lifting elements comprise in each case one rail with a running surface which runs in the transverse direction. The rail of a respective lifting element and the rail arrangement of the further magazine levels are advantageously adapted to one another in such a way that the rails of the lifting elements which are arranged on a magazine level form, with the rail arrangement of this magazine level, a continuous transport running surface which runs in the transverse direction. In the case of this refinement, there is not in this regard a continuous transport running surface which runs in the transverse direction on the further magazine levels, on which the lifting elements are not arranged, and no carrier elements, in particular, can be transported in the transverse direction in these further magazine levels as long as the lifting elements are not moved into the corresponding magazine level, in order thus to form the transport running surface which runs continuously in the transverse direction there. Here, the rail, described in conjunction with this refinement, of a respective lifting element is provided, in particular, in addition to the rail element of a respective lifting element, in which the toothed rack can be guided.

For transporting the carrier elements in the transverse direction, it is provided, in particular, that the carrier elements comprise transverse direction running rollers which are arranged on the front side with in each case a rotational axis which extends in the longitudinal direction. The carrier elements can be moved by means of the transverse direction running rollers along the transport running surface which, as described above, is advantageously formed by way of the respective rail arrangement on one of the further magazine levels and the respective rail of the lifting elements.

In accordance with one advantageous development, the rail of the respective lifting element is formed by way of a U-profile, the openings of the U-profiles of the lifting elements being arranged so as to lie opposite one another, in particular being arranged so as to lie opposite one another at a spacing, and the running surfaces of the rails of the lifting elements being formed in each case by way of an inner side of a lower outer limb of the U-profile. The rail arrangements of the further magazine levels of the magazine of the processing station advantageously likewise comprise corresponding U-profiles which can advantageously be connected seamlessly to the U-profiles of the lifting elements by way of an adjustment of the lifting elements. The carrier elements are advantageously additionally secured by way of the U-profiles, since they advantageously limit a movement of the carrier elements in the longitudinal direction and in the vertical direction.

The carrier elements further advantageously have support rollers which are arranged on the front side with in each case a rotational axis which extends in the vertical direction. The support rollers are advantageously configured to be supported against an inner side of an inner limb of a respective U-profile and to roll on the inner side of the inner limb during a transport of one of the carrier elements in the transverse direction in one of the further magazine levels. As a result, the smooth running of the carrier elements is advantageously improved. Furthermore, a movement of the carrier elements in the longitudinal direction and in the vertical direction is further limited in an improved manner.

A further advantageous refinement of the processing station provides that the third transport apparatus comprises in each case two lifting columns lying opposite one another. In total, the third transport apparatus therefore comprises four lifting columns, of which advantageously in each case the two lifting columns which are arranged on one side of the magazine form a lifting column pair. The respective lifting element can be moved in the vertical direction between the two lifting columns which are arranged on one side of the magazine. Here, the lifting elements are advantageously guided laterally in the lifting columns. The rails of the lifting elements can thus advantageously be inserted precisely into the rail arrangements of the further magazine levels. Here, the rails of the lifting elements and the respective toothed rack are advantageously arranged in front of the lifting columns, the toothed rack being arranged, in particular, closer to the lifting columns than the rail.

In accordance with a further advantageous refinement, the first transport apparatus of the processing station has a rail arrangement for guiding and supporting the carrier elements, and at least one first drive arrangement, with two transmission elements which are oriented parallel to the rail arrangement of the first transport apparatus. Here, the transmission elements can advantageously be coupled independently of one another to the respective carrier element to be transported, in order to move the carrier element in a coupled state in the longitudinal direction. The carrier elements can advantageously be moved by way of a first transport apparatus, configured in this way, effectively and efficiently from the work region into the provision point and from the provision point into the work region of the processing station. It is advantageous, in particular, for the first transport apparatus to be configured like the transport apparatus described in EP 3 490 877 B1 for transporting the clamping frames in the longitudinal direction, reference being made explicitly hereby to the disclosure of EP 3 490 877 B1. The clamping frames according to EP 3 490 877 B1 are, in particular, carrier elements which comprise clamping apparatuses here.

It is provided, in particular, that the transmission elements comprise toothed racks for transmitting a moving movement in the longitudinal direction, a toothing system of the toothed racks advantageously being directed vertically downward. Further advantageously, the first drive arrangement of the first transport apparatus comprises respective drives which are operatively connected to the transmission elements. In particular, it is provided, furthermore, that driver elements for coupling the carrier elements to the transmission elements are arranged on end regions, opposite one another in the longitudinal direction, of the transmission elements of the first transport apparatus. It is further advantageous that the first drive arrangement of the first transport apparatus comprises activation actuators, preferably pneumatically actuable activation actuators. Via the latter, the driver elements can advantageously be coupled to the carrier elements in respective transfer positions of the transmission elements. The carrier elements preferably have coupling pins, via which the carrier elements can be coupled in a positively locking manner to the driver elements of the transmission elements of the first transport apparatus.

The first transport apparatus of the processing station extends, in particular, in the longitudinal direction from the provision point of the magazine, via a transfer region as far as into the work region. Here, the first drive arrangement of the first transport apparatus is preferably arranged in the transfer region. In particular, the rail arrangement of the first transport apparatus forms rail portions which are separated from one another in the first magazine level and/or in the transfer region and/or in the work region, it being possible, in particular, for the rail portion which is arranged in the first magazine level to be moved in the transverse direction by means of a second drive arrangement of the second transport apparatus of the processing station. It can also be provided, furthermore, that the rail portion which is arranged in the transfer region and/or the rail portion which is arranged in the work region can also be moved in the transverse direction by means of a further drive arrangement.

It is provided as a further advantageous refinement that the second transport apparatus of the processing station comprises a rail arrangement, the rail arrangement having rail pairs which can be adjusted in the transverse direction for the transport of the carrier elements, the rail pairs being formed, in particular, from U-profiles, the openings of which lie opposite one another. Further advantageously, the carrier elements comprise longitudinal direction running rollers which are arranged on both sides with in each case a rotational axis which extends in the transverse direction, it being possible for the carrier elements to be moved in the longitudinal direction by means of the longitudinal direction running rollers, in particular between the work region and the provision point of the processing station. Here, the longitudinal direction running rollers advantageously roll within the respective U-profile during transport of one of the carrier elements into the provision point or from the provision point. On their upper limb, that is to say the upper outer limb, the U-profiles advantageously each have recesses which are arranged above the longitudinal direction running rollers of one of the carrier elements when the carrier element is situated at the provision point. The carrier elements can advantageously thus be transported by means of the third transport apparatus of the processing station out of the rail arrangement of the second transport apparatus, specifically out of the U-profiles, in the vertical direction.

The method which is proposed, furthermore, for transporting a carrier element from a starting position in a magazine of the processing station into a work region of the processing station, the processing station being configured according to the invention and comprising, in particular, the features stated above individually or in combination, and the carrier elements supporting, in particular, clamping frames which are different configuration, provides that the carrier element to be transported is arranged, as starting position, in a magazine level outside the first level, in particular above the first level, outside the third transport apparatus, and is moved from there into the work region with the use of the transport apparatuses of the processing station. To this end, the lifting elements are first of all moved by means of the third transport apparatus to the magazine level, in which the carrier element to be transported is arranged, that is to say to the magazine level, in which the starting position of the carrier element to be transported is situated. By means of the fourth transport apparatus, the carrier element to be transported is then transported in the transverse direction until the carrier element to be transported is arranged on the front side in the lifting elements. Furthermore, the carrier element to be transported is transported in the vertical direction into the provision point in the first level by means of the third transport apparatus by way of vertical movement of the lifting elements. In a further step, the carrier element to be transported is transported from the provision point in the transverse direction out of the provision point by means of the second transport apparatus. Subsequently, the lifting elements are moved by means of the third transport apparatus in the vertical direction into a magazine level outside the first level, in particular above the first level, with the result that the lifting elements, in particular, no longer block the transport path in the longitudinal direction. The carrier element to be transported is then transported by means of the second transport apparatus in the transverse direction into the provision point, and the carrier element to be transported is transported by means of the first transport apparatus in the longitudinal direction from the provision point into the work region.

For the transport of the carrier element in the magazine level, in which the starting position of the carrier element is situated, it is provided, in particular, that a toothed rack, comprising a driver element, of the fourth transport apparatus is moved in the transverse direction. During the movement, the driver element is advantageously in a decoupling position. The movement of the toothed rack is advantageously stopped when the driver element is situated at the level of a coupling element of the carrier element to be transported. The driver element is then advantageously moved into the coupling position, and the carrier element is coupled to the toothed rack in this way. The toothed rack is then advantageously moved in the opposite direction and in this way the carrier element is pulled into the lifting elements or the U-profiles, provided for this purpose, of the lifting elements. The driver element is then advantageously moved into the decoupling position, and the toothed rack is advantageously moved again into the original position, in which the lifting element can be moved in the vertical direction.

The method which is, furthermore, proposed for transporting a carrier element from a work region of the processing station into a target position in a magazine of the processing station, the processing station being configured according to the invention and comprising, in particular, the features stated above individually or in combination, and the carrier elements supporting, in particular, clamping frames of different configuration, provides that the carrier element to be transported is intended to be arranged, as target position, in a magazine level outside the first level, in particular above the first level, outside the third transport apparatus, and is moved there from the work region. To this end, the lifting elements are moved by means of the third transport apparatus in the vertical direction into a magazine level outside the first level. The carrier element to be transported is then transported by means of the first transport apparatus in the longitudinal direction from the work region into the provision point. By means of the second transport apparatus, the carrier element to be transported is subsequently transported from the provision point in the transverse direction out of the provision point, in particular in such a way that the carrier element to be transported is arranged outside the third transport apparatus. By means of the third transport apparatus, the lifting elements are then moved to the first magazine level. When this has taken place, the carrier element to be transported is transported by means of the second transport apparatus in the transverse direction again into the provision point until the carrier element to be transported is arranged on the front side in the lifting elements. By means of the third transport apparatus, the carrier element to be transported is transported by way of vertical movement of the lifting elements in the vertical direction from the provision point into the further level, in which the target position for the carrier element to be transported is situated. The carrier element to be transported is then transported by means of the fourth transport apparatus in the transverse direction into the target position.

For the transport of the carrier element in the transverse direction in the further magazine level, in which the target position is situated, it is provided, in particular, that a toothed rack, comprising a driver element, of the fourth transport apparatus is moved in the transverse direction. During the movement, the driver element is advantageously in a decoupling position. The movement of the toothed rack is advantageously stopped when the driver element is situated at the level of a coupling element of the carrier element to be transported. The driver element is then advantageously moved into the coupling position, and the carrier element is coupled to the toothed rack in this way. The carrier element to be coupled is then advantageously transported into the target position by way of a movement of the toothed rack. The driver element is then advantageously moved into the decoupling position, and the toothed rack is advantageously moved again into the original position, in which the lifting element can be moved in the vertical direction. The carrier element is advantageously secured in the target position.

The transporting of the carrier elements from the work region into the provision point or from the provision point into the work region by means of the first transport apparatus can take place here, in particular, as described in EP 3 490 877 B1, to which reference is made explicitly in this regard.

In particular, a combination of the above-described methods is also provided. In particular, intermediate displacements of carrier elements are additionally provided, with the result that a starting position is produced which allows the above-described methods to be carried out.

Further advantageous details, features and embodiment details of the invention will be explained in greater detail in conjunction with the exemplary embodiments which are shown in the figures, in which:

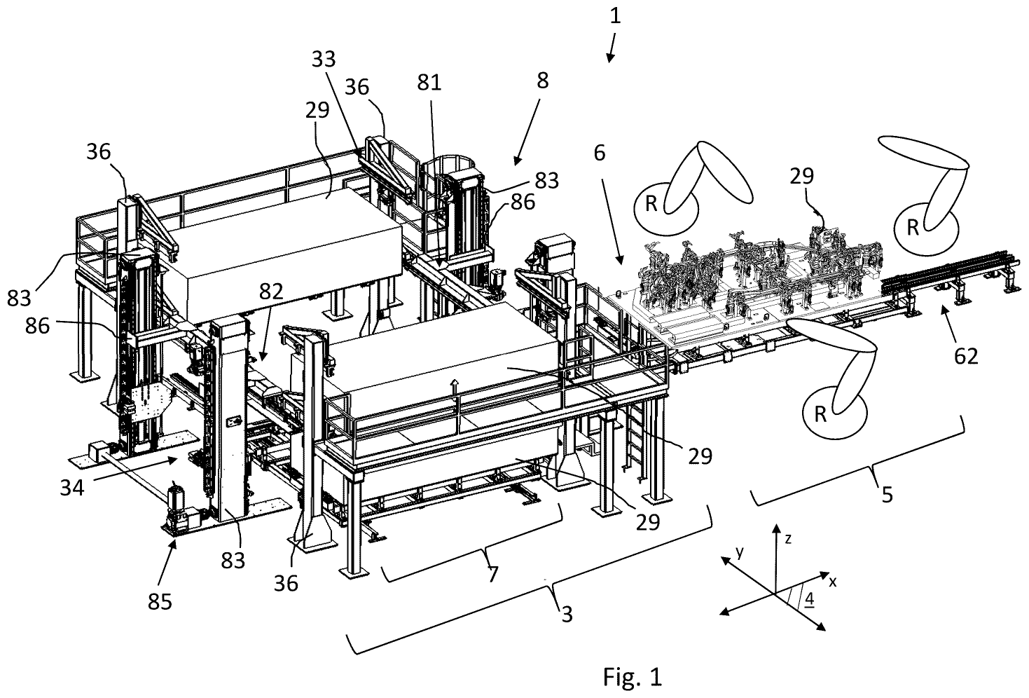

FIG. 1 shows a perspective view of one exemplary embodiment for a processing station which is configured according to the invention,

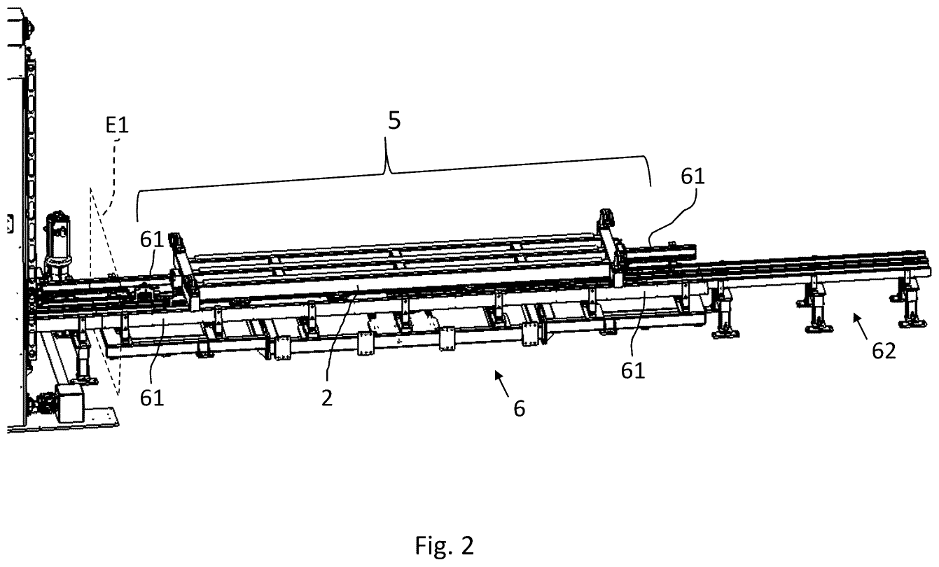

FIG. 2 shows a detail of the processing station according to FIG. 1, which detail shows the first transport apparatus and the work region 5,

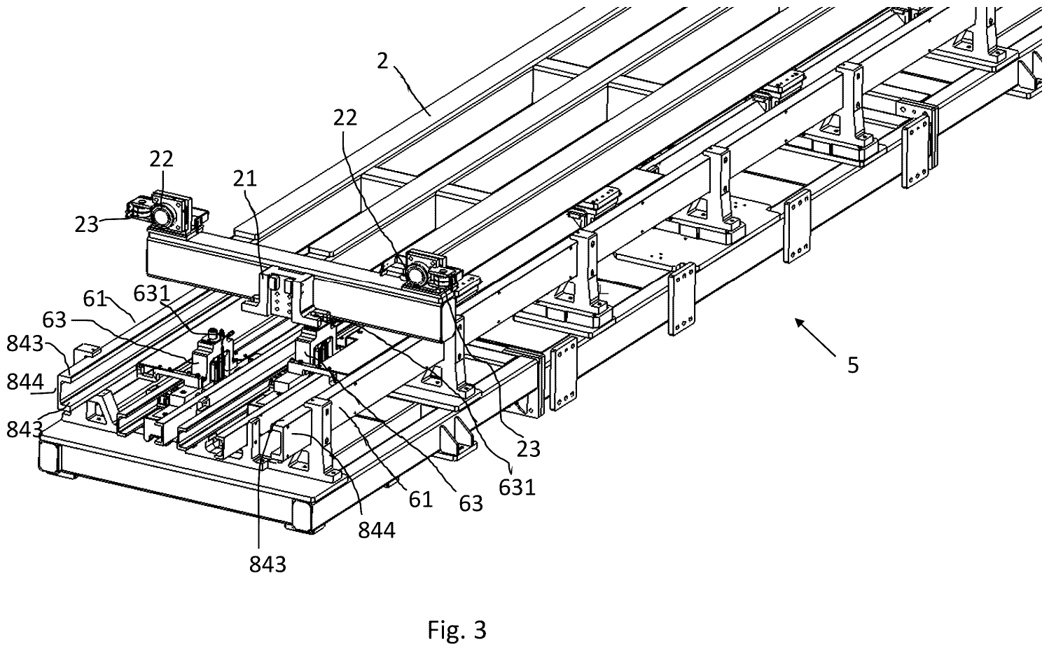

FIG. 3 shows a further detail of the processing station according to FIG. 1,

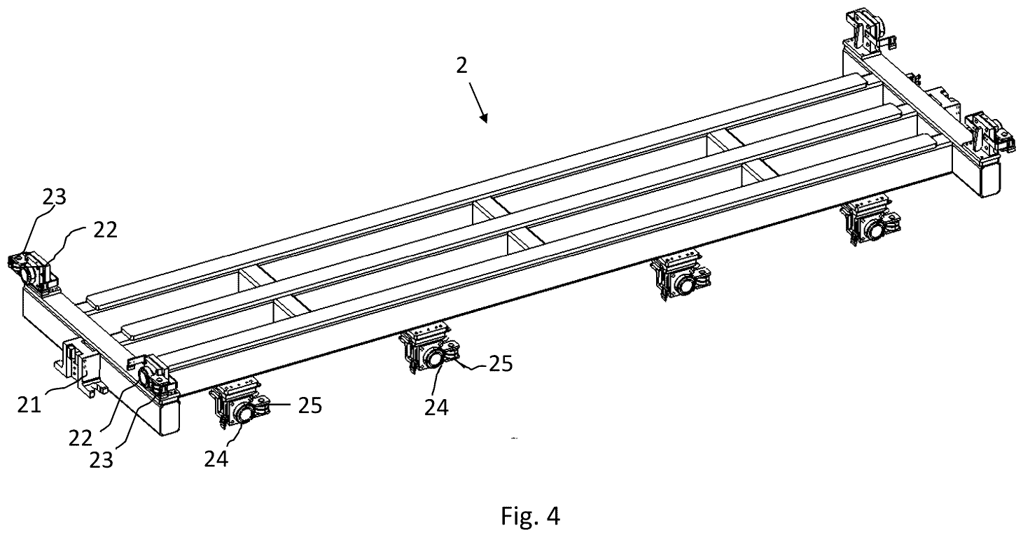

FIG. 4 shows a carrier element of the processing station according to FIG. 1 without a workpiece receiving element,

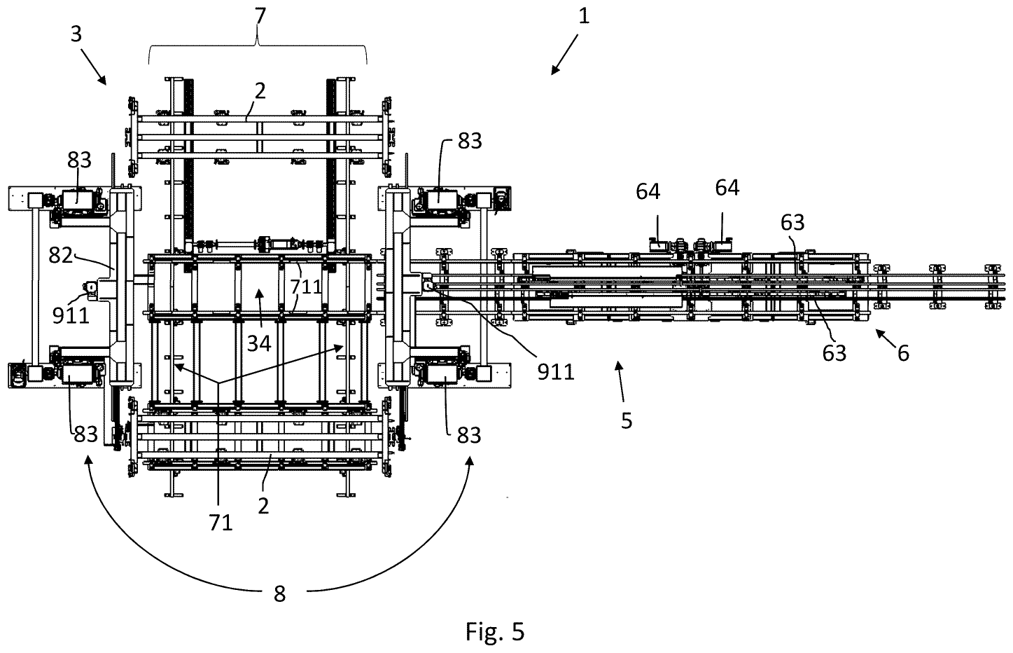

FIG. 5 shows a plan view of the processing station according to FIG. 1 with only two carrier elements without illustration of the workpiece receiving elements,

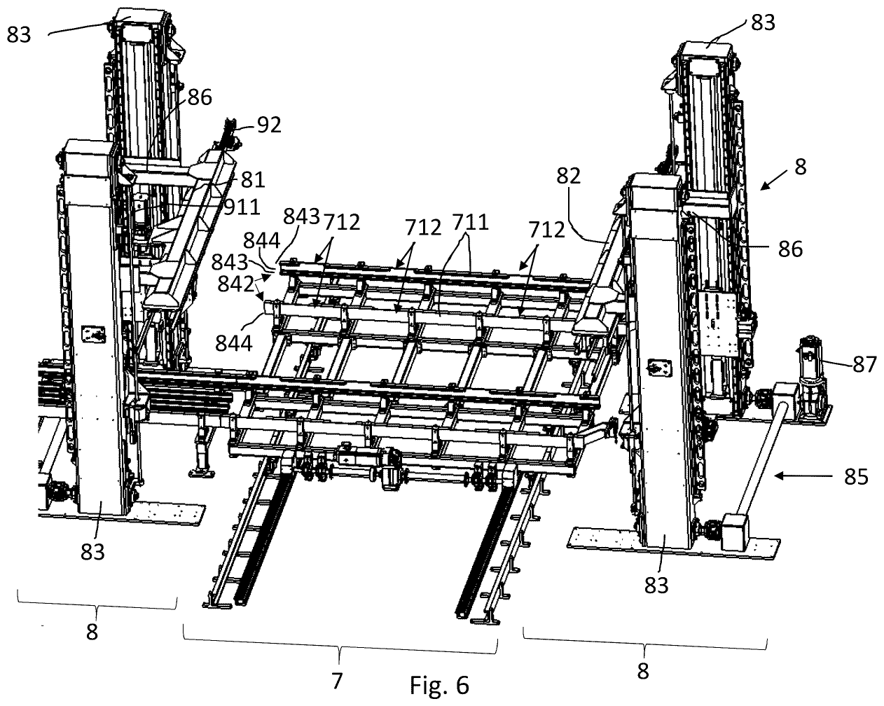

FIG. 6 shows a detail of the processing station according to FIG. 1 with the second transport apparatus 7 and the third transport apparatus 8 without illustration of carrier elements,

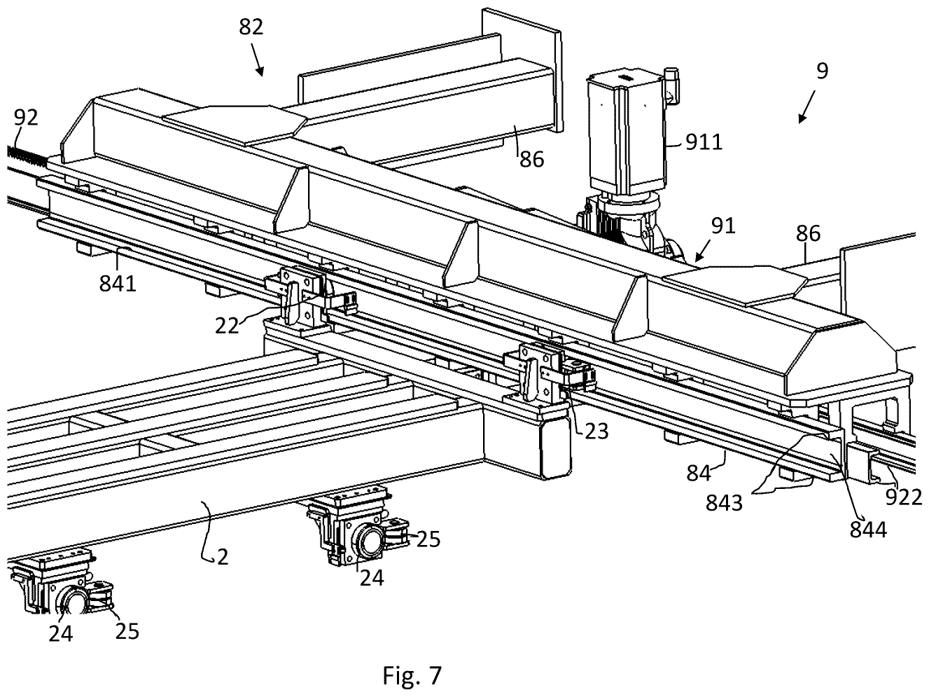

FIG. 7 shows a detail of the processing station according to FIG. 1 with a lifting element and a carrier element arranged in the lifting element, without illustration of a workpiece receiving element,

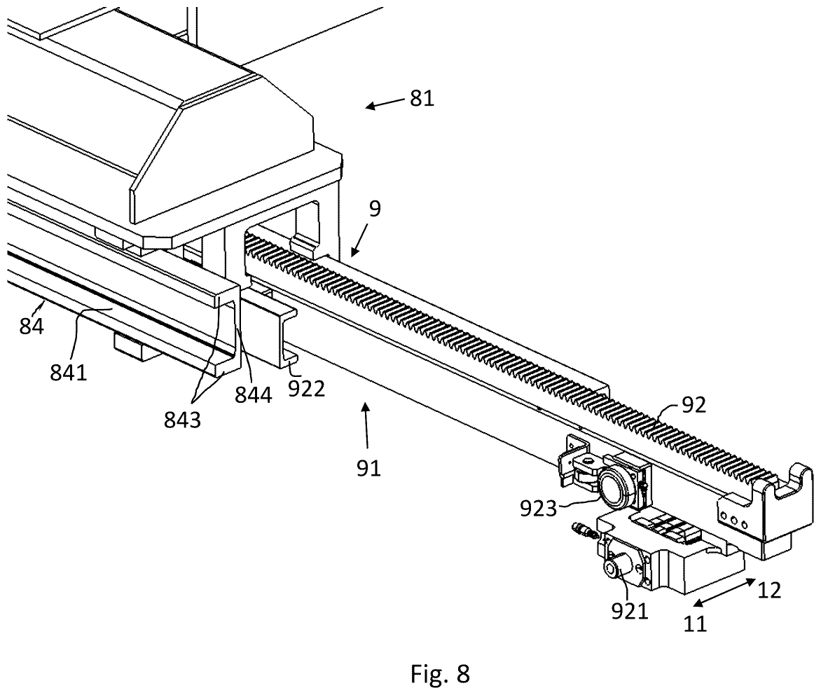

FIG. 8 shows a detail of the lifting element of the processing station according to FIG. 1,

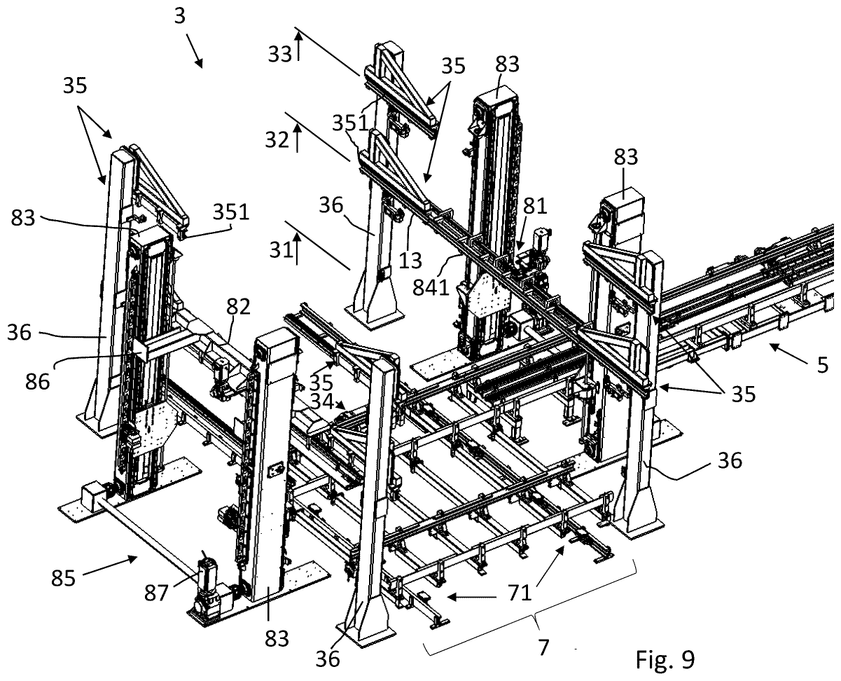

FIG. 9 shows a detail of the processing station according to FIG. 1 with the magazine, the second transport apparatus, the third transport apparatus and a part of the first transport apparatus without illustration of carrier elements, and

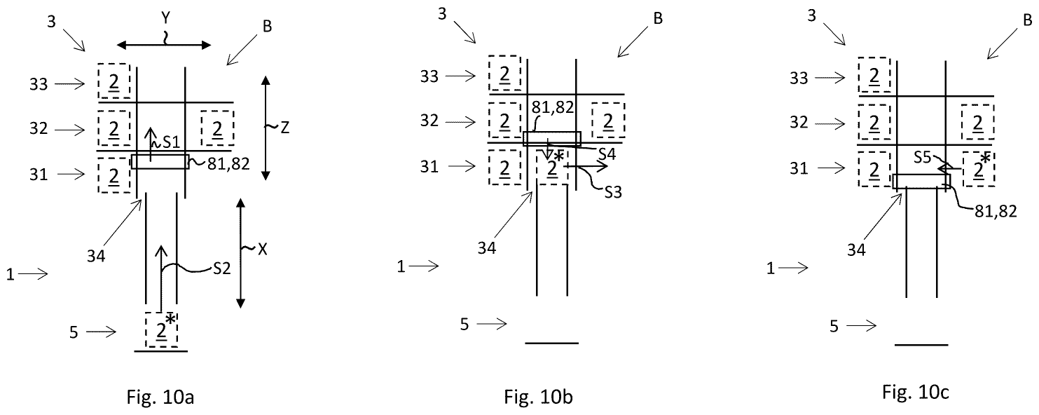

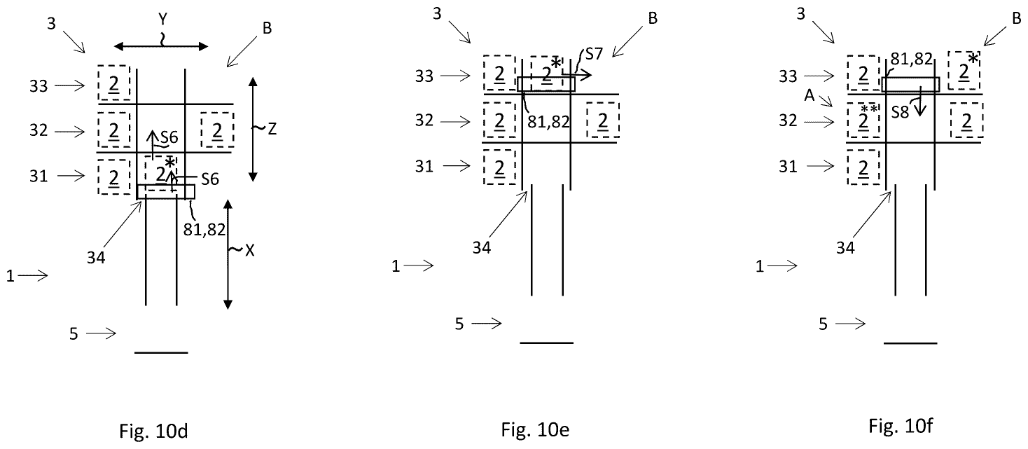

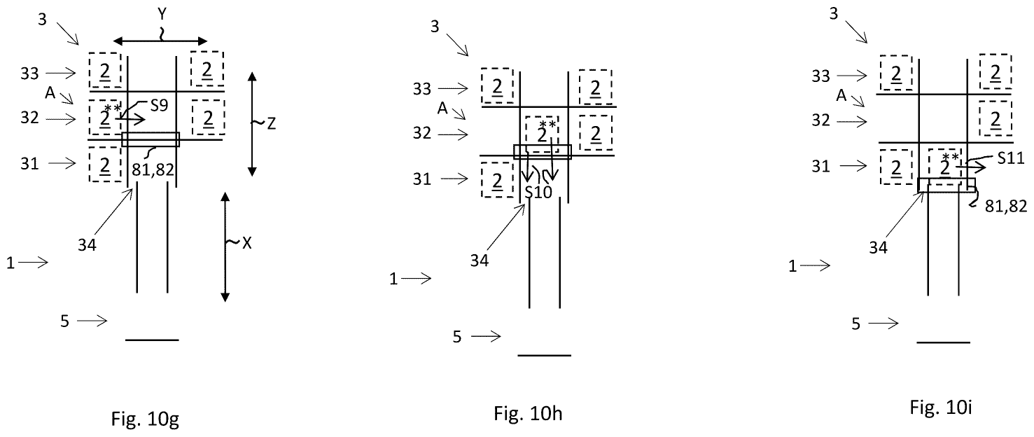

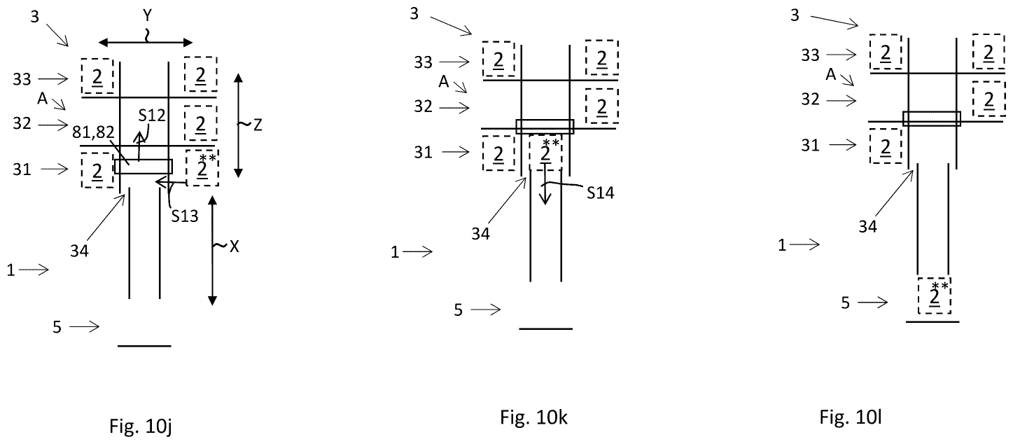

FIG. 10a show greatly simplified illustrations of one exemplary embodiment for methods which are configured according to the invention and by way of which a to FIG. 10l carrier element arranged in a work region of a processing station can be exchanged for a carrier element arranged in a magazine.

In the different figures, identical parts are as a rule provided with the same designations, and are therefore sometimes also explained only in conjunction with one of the figures.

FIG. 1 shows one exemplary embodiment for a processing station 1 which is configured according to the invention. Further perspectives, parts and details of this exemplary embodiment are shown in FIG. 2 to FIG. 9.

This processing station 1 is configured for processing workpieces, in particular workpieces which are configured as vehicle body parts. The processing station 1 comprises to this end a work region 5, in which the processing of the workpieces can take place. In the case of a use as intended of the processing station 1, it is provided, in particular, that the processing station 1 is arranged within a production plant. In this production plant, robots are preferably used to convey and process workpieces, in particular vehicle body parts. Here, the processing station 1 serves to process the workpieces in a predefined section of the production plant. The processing of the workpieces can comprise, for example, a joining operation, for example welding of the workpieces by means of welding robots R are which are shown diagrammatically in FIG. 1. In particular, what is known as a GEObox be arranged in the work region 5 of the processing station, in which GEObox the actual processing of the workpieces takes place and to which a currently required clamping apparatus, in particular a currently required clamping frame, is delivered by way of transporting of a carrier element 2, comprising the clamping apparatus, in the transverse direction Y. That is to say, it is provided at least as a design variant that the work region 5 comprises a further transport apparatus, by way of which a carrier element 2 can be transported in the work region 5 in the transverse direction Y, it being possible for this further transport apparatus to be configured, in particular, like the second transport apparatus. With regard to a possible configuration of the work region 5 of the processing station, reference is additionally made to the disclosure in this regard in EP 3 490 877 B1.

In order for it to be possible for workpieces of different configuration, in particular vehicle body parts of different configuration, to be processed in a simple way by way of the processing machine 1, the processing machine 1 in the exemplary embodiment which is shown in FIG. 1 has four carrier elements 2 which are each configured to receive workpieces of different configuration. To this end, the carrier elements 2 of the processing station 1 correspondingly have differently configured workpiece receiving elements 29, in particular differently configured clamping frames, which are shown diagrammatically in the figures in a simplified manner as cuboids. One example for a specific embodiment of a carrier element 2 with a workpiece receiving element 29* and vehicle body components received by the workpiece receiving element 29* is shown by the carrier element 2 which is arranged in the work region 5 in FIG. 1. The processing station 1 which is shown in FIG. 1 is configured for a total of five carrier elements 2.

In order to provide the carrier elements 2, the processing station 1 comprises a magazine 3. Here, in a first level 4, the magazine 3 comprises a first, lowermost magazine level 31 which is arranged in the same level 4 as the work region 5. Above the first magazine level 31, the magazine 3 comprises a middle magazine level 32 and an upper magazine level 33 as further magazine levels. In order for it to be possible for the carrier elements 2 to be exchanged between the work region 5 and the magazine 3, the processing station 1 comprises a plurality of transport apparatuses.

The processing station 1 thus has a first transport apparatus 6, by way of which a carrier element 2 of the processing station 1 can be transported between the work region 5 and a provision point 34 of the magazine 3 in the longitudinal direction X. The provision point 34 lies centrally in the first magazine level 31 of the magazine 3. The provision point 34 is a point, to which each carrier element 2 has to first of all be moved, in order for it to be possible for it to be transported from the magazine 3 into the work region 5. Each carrier element 2 which is intended to be moved from the work region 5 into the magazine 3 also likewise has to be transported first of all to the provision point 34.

For the transport of the carrier elements 2 between the work region 5 and the provision point 34, the first transport apparatus 6 in this exemplary embodiment has a rail arrangement 61 for guiding and supporting the carrier elements 2. Here, the rail arrangement 61 comprises running surfaces which are oriented in the longitudinal direction X and on which the carrier elements 2 can be moved in the longitudinal direction X by way of the longitudinal direction running rollers 24 which are arranged laterally on the carrier elements 2. In order for it to be possible for the carrier elements 2 to be moved, the first transport apparatus 6 additionally comprises a first drive arrangement 62 with two transmission elements 63 which are oriented parallel to the rail arrangement 61. The transmission elements 63 can be coupled independently of one another to the respective carrier element to be transported. To this end, in particular, the transmission elements have driver elements of corresponding configuration which can each be coupled to a coupling element of corresponding configuration of a carrier element 2. By means of the transmission elements 63, a coupled carrier element 2 can be moved in the longitudinal direction X. For the transmission of the moving movement in the longitudinal direction X, the transmission elements 63 in this exemplary embodiment comprise toothed racks which, in particular guided on rollers, are arranged in two U-profiles with mutually facing openings. The first drive arrangement 62 of the first transport apparatus 6 additionally comprises drives 64 which are operatively connected to the transmission elements 63, can be configured, in particular, as electric motors, and are shown in FIG. 5. The toothing system of the toothed racks is preferably directed vertically downward.

Further details of the processing station 1 with the work region 5 and the first transport apparatus 6 are shown in the details, shown in FIG. 2 and FIG. 3, of the processing station 1 from the exemplary embodiment according to FIG. 1, in which details the carrier element 2 which is shown is shown without a workpiece receiving element 29, as in FIG. 1, in order to improve the visibility of details of the carrier element 2. Here, FIG. 2 illustrates a sectional plane E1, FIG. 3 showing the part of the processing station 1 from the sectional plane E1. It can be seen here in FIG. 3 that the rail arrangement 61 comprises U-profiles, along which a carrier element 2 of the processing station 1 can be moved by way of laterally arranged longitudinal direction running rollers 24 which are shown in FIG. 4. Here, the longitudinal direction running rollers 24 roll over the inner side of the lower outer limb 843 of a respective U-profile of the rail arrangement 61. Side support rollers 25 of the carrier element 2 which can roll on the inner side of the inner limbs 844 of the U-profiles of the rail arrangement 61 stabilize the carrier element 2 during the movement in the longitudinal direction X. In addition, FIG. 3 shows the transmission elements 63 which are likewise guided in U-profiles with the driver elements 631 which are arranged thereon. Here, in relation to FIG. 3, the driver element 631 of the right-hand transmission element 63 is coupled to the coupling element 21 of the carrier element 2 in the illustration which is shown, with the result that the carrier element 2 can be transported by means of the transmission element 63 in the longitudinal direction X. The driver elements 631 can be adjusted correspondingly in order to decouple the driver elements 631 from the coupling elements 21 of the carrier elements 2.

For the transport of the carrier elements 2 of the processing station 1 in the transverse direction Y in the first magazine level 31 of the magazine 3, the processing station 1 comprises a second transport apparatus 7 which is shown in greater detail, in particular, in FIG. 6. In this exemplary embodiment, the second transport apparatus 7 comprises a rail arrangement 71, the rail arrangement 71 having rail pairs 711 which are adjustable in the transverse direction Y for the transport of the carrier elements 2. Here, in this exemplary embodiment, the rail pairs 711 are formed from U-profiles with two outer limbs 843 which surround an inner limb 844. The U-profiles are arranged here in such a way that the openings 842 of the U-profiles lie opposite one another such that they are spaced apart, in such a way that the carrier elements 2 can be moved in the longitudinal direction X by way of the longitudinal direction running rollers 24 which are arranged on both sides into a rail pair 711 of this type which is formed from the U-profiles, coming from the work region 5 of the processing station 1. In the case of moving into a rail pair 711 of this type or moving out of a rail pair 711 of this type, the longitudinal direction running rollers 24 roll within the U-profile, in particular on the inner side of the lower outer limb 843. On the upper outer limbs 843 of the U-profiles of these rail pairs 711, the U-profiles each have recesses 712. Here, these recesses 712 are arranged above the longitudinal direction running rollers 24 of a respective carrier element 2 when the carrier element 2 is arranged completely at the provision point 34. These recesses 712 make it possible here that a carrier element 2 which is situated at the provision point 34 can be moved in the vertical direction Z out of a rail pair 711 or into a rail pair 711.

In order that a carrier element 2 can be transported in the vertical direction Z within the magazine 3 of the processing station 1, the processing station 1 comprises a third transport apparatus 8, details of the third transport apparatus 8 being shown, inter alia, in FIG. 6. By way of the transport apparatus 8, a carrier element 2 can be moved from one magazine level to another magazine level, the movement in the vertical direction Z taking place within the base area defined by way of the provision point 34. In this exemplary embodiment, the third transport apparatus 8 has two lifting elements 81, 82 which can be adjusted in the vertical direction Z. Furthermore, the third transport apparatus 8 has two lifting column pairs, it being possible for a respective lifting element 81, 82 to be moved in the vertical direction Z between the lifting columns 83 of a lifting column pair. Here, the lifting column pairs are each assigned a drive arrangement 85 which comprises, in particular, in each case one electric motor 87. The lifting elements 81, 82 are moved, in particular, synchronously at an identical height. Further details of a lifting element 82 are shown, in particular, in FIG. 7 and FIG. 8.

In this exemplary embodiment, the lifting elements 81, 82 of the third transport apparatus 8 of the processing station 1 each comprise a rail 84 which is formed by way of a U-profile and is connected adjustably to the lifting columns 83 via two arms 86. Here, the U-profile comprises two outer limbs 843 and an inner limb 844, the openings 842 of the U-profiles being arranged in a manner which is spaced apart and lies opposite one another in such a way that a carrier element 2 of the processing station 1 can be received on the front side by the U-profiles and therefore by the lifting elements 81, 82. Here, the inner side of a lower outer limb 843 of a respective U-profile forms a running surface 841 which runs in the transverse direction Y. For transport of a carrier element 2 in the transverse direction Y in the middle magazine level 32 or the upper magazine level 33, the running surface 841 forms the part of a transport running surface 13 which runs in the transverse direction Y.

To this end, the middle magazine level 32 and the upper magazine level 33 of the magazine 3 of the processing station 1 each comprise a rail arrangement 35 with running surface portions 351 which run in the transverse direction Y and are formed by way of U-profiles as in the case of the rails 84 of the lifting elements 81, 82. Reference is made, in particular, to FIG. 9 with respect to the embodiment of the rail arrangement 35 of the magazine 3. Here, the rail 84 of a lifting element 81, 82 and the rail arrangement 35 of the middle magazine level 32 and the upper magazine level 33 are adapted to one another in such a way that the rails 84 of the lifting elements 81, 82 which are arranged on a magazine level 32, 33 form, with the rail arrangement 35 of this magazine level 32, 33, the continuous transport running surface 13 which runs in the transverse direction Y.

In order that the carrier elements 2 can be moved in the transverse direction Y along these transport running surfaces 13, the carrier elements 2 each comprise transverse direction running rollers 22 which are arranged on the front side (as shown, in particular, in FIG. 4) and each comprise a rotational axis which extends in the longitudinal direction X. By means of these transverse direction running rollers 22, the carrier elements 2 can be moved along the transport running surface 13 which is formed from the running surface 841 of the rail 84 of a respective lifting element 81, 82 and the running surface portions 351 of a respective rail arrangement 35. In addition to the transverse direction running rollers 22, the carrier elements 2 in this exemplary embodiment each have support rollers 23 which are arranged on the front side with in each case a rotational axis which extends in the vertical direction Z. The support rollers 23 are configured here to be supported against the inner side of the inner limb 844 of the U-profile of a respective lifting element 81, 82. To this end, the support rollers 23 can roll on the inner side of the inner limb 844 during transport of a carrier element 2 in the transverse direction Y on the middle magazine level 32 or the upper magazine level 33.

In order for it to be possible for the carrier elements 2 of the processing station 1 to be moved on the middle magazine level 32 or the upper magazine level 33 in the transverse direction Y along the transport running surface 13, the lifting elements 81, 82 comprise a fourth transport apparatus 9, the details of which are shown, in particular, in FIG. 7 and FIG. 8. Here, the fourth transport apparatus 9 comprises two drive arrangements 91, each of the lifting elements 81, 82 having in each case one of the drive arrangements 91 of the fourth transport apparatus 9. Here, the drive arrangement 91 of the fourth transport apparatus 9 comprises in each case one toothed rack 92 which can be moved in the transverse direction Y. In order to move the respective toothed rack 92, it is provided that the drive arrangements 91 each have a drive unit 911, in particular an electric motor, the drive units 911 each being arranged on one of the lifting elements 81, 82. By means of the respective drive unit 911, the toothed racks 92 can be moved in the transverse direction Y, it being provided, in particular, that the toothed racks 92 are moved synchronously. In order to transmit the movement of the toothed racks 92 to the carrier elements 2, the toothed racks 92 each have a driver element 921 for coupling to a coupling element 21 of a respective carrier element 2. Here, the driver element 921 can be adjusted between a coupling position 11 and a decoupling position 12, in particular in order for it to be possible in this way for a respective toothed rack 92 to be coupled to a carrier element 2. If a carrier element 2 of the processing station 1 is coupled to the toothed racks 92, the coupled carrier element 2 can be transported in the middle magazine level 32 or the upper magazine level 33 in the transverse direction Y by way of a movement of the toothed racks 92. Here, the toothed racks 92 are mounted such that they can be moved in the transverse direction Y in a rail arrangement 922, formed from U-profiles, of the fourth transport apparatus 9 via running rollers 923 which are formed laterally on the toothed racks 92. It is provided, in particular, that the toothed racks of the first transport apparatus 6 are configured and mounted in the same way as the toothed racks 92 of the fourth transport apparatus 9, as a result of which the diversity of parts is advantageously reduced and therefore costs can be saved.

A method for changing a carrier element 2 will be explained in greater detail in the following text with reference to the diagrammatic illustrations in FIG. 10a to FIG. 10l. It is first of all explained here on the basis of FIG. 10a to FIG. 10f how a carrier element 2* is moved from the work region 5 of a processing station 1 into a target position B in a magazine 3 of the processing station 1, and it is subsequently explained on the basis of FIG. 10f to FIG. 10l how a carrier element 2** is moved from a starting position A out of the magazine 3 into the work region 5. Here, the processing station 1 can also be configured, in particular, like the processing station 1 according to the above-explained exemplary embodiment. It is provided in the present case, however, that the second transport apparatus 7 can also move one individual carrier element 2 in the transverse direction Y when two carrier elements 2 are situated in the first magazine level 31, and the second transport apparatus 7 therefore cannot only move these two carrier elements 2 jointly in the transverse direction Y, as in the case of the exemplary embodiment according to FIG. 1 to FIG. 9. In order to explain the method on the basis of FIG. 10a to FIG. 10l, designations of FIG. 1 to FIG. 9 are also used even if these are not shown in part in FIG. 10a to FIG. 10l.

FIG. 10a to FIG. 10l show the processing station 1 with the magazine 3 and the work region 5 in greatly simplified form. Here, the magazine 3 comprises a first, lower magazine level 31, a second, middle magazine level 32, and a third, upper magazine level 33. The work region 5 is situated at the same level as the first, lower magazine level 31. The maximum possible number (in this exemplary embodiment) of four further carrier elements 2 are provided in the magazine 3. Further carrier elements might be provided, however, by way of the provision of further magazines or further magazine levels in the magazine 3.

FIG. 10a shows a carrier element 2* which is intended to be moved out of the work region 5 of the processing station 1 into the target position B in the magazine 3 of the processing station 1. Here, the target position B lies in the third, upper magazine level 33 outside the third transport apparatus 8. The provided method steps are shown in FIG. 10a to FIG. 10l by way of arrows S1 to S14.

FIG. 10a shows that, in a first step S1, the lifting elements 81, 82 are moved by means of the third transport apparatus 8 in the vertical direction Z into the second, middle magazine level 32. As a result, the path for the carrier element 2* is cleared, in order for it to be possible for the latter to be moved into the provision point 34. In a second step S2, the carrier element 2* to be transported is transported by means of the first transport apparatus 6 in the longitudinal direction X from the work region 5 into the provision point 34.

FIG. 10b shows that, in a third method step S3, the carrier element 2* to be transported is transported by means of the second transport apparatus 7 from the provision point 34 in the transverse direction Y out of the provision point 34, by the carrier element 2* being displaced to the right. As a result, the path is cleared for it to be possible, in a fourth step S4, for the lifting elements 81, 82 to be moved again into the first magazine level 31 by means of the third transport apparatus 8.

When the lifting elements 81, 82 are in the first, lower magazine level 31 again, the carrier element 2* to be transported can be moved again into the processing point 34 in a further method step S5, as shown symbolically in FIG. 10c, in such a way that the carrier element 2* to be transported is arranged on the front side in the lifting elements 81, 82. It is shown in FIG. 10d how, in a further method step S6, the carrier element 2* to be transported is transported by way of vertical movement of the lifting elements 81, 82 by means of the third transport apparatus 8 in the vertical direction Z from the provision point 34 into the third, upper magazine level 33, in which the target position B is situated.

In a further method step S7 which is shown in FIG. 10e, the carrier element 2* to be transported is transported by means of the fourth transport apparatus 9 in the transverse direction Y into the target position B. FIG. 10f shows the carrier element 2* to be transported in its target position B.

In addition, FIG. 10f shows a further carrier element 2** which is provided in a starting position A which lies on the left in the second, middle magazine level 32, and is intended to be transported from there into the work region 5. To this end, in a further step S8, the lifting elements 81, 82 are moved from the third, upper magazine level 33 into the second, middle magazine level 32.

FIG. 10g shows that, in a further method step S9, the carrier element 2** which is now to be transported is transported by means of the fourth transport apparatus 9 in the transverse direction Y. The transport in the transverse direction Y takes place here until the carrier element 2** to be transported is arranged on the front side in the lifting elements 81, 82. By means of the third transport apparatus 8, the carrier element 2** to be transported is transported by way of a vertical movement of the lifting elements 81, 82 in a further method step S10 in the vertical direction Z into the provision point 34 in the first, lower magazine level 4, as shown in FIG. 10h.

As shown in FIG. 10i, the carrier element 2** to be transported is transported in a next method step S11 by means of the second transport apparatus 7 from the provision point 34 in the transverse direction Y out of the provision point 34 to the right, in order that, in a next step S12 which is shown in FIG. 10j, the lifting elements 81, 82 can be moved by means of the third transport apparatus 8 in the vertical direction Z into a magazine level 32, 33 above the first, lower magazine level 31, and the path for transport out of the provision point 34 in the longitudinal direction X is thus cleared.

In a further method step S13 which is likewise shown in FIG. 10j, the carrier element 2** to be transported is transported by means of the second transport apparatus 7 in the transverse direction Y to the left into the provision point 34. Finally, in a method step S14, the carrier element 2** to be transported is transported by means of the first transport apparatus 6 in the longitudinal direction X from the provision point 34 into the work region 5. FIG. 10l shows the carrier element 2** which is arranged in the work region 5.

Different vehicle body parts can advantageously be processed in the work region 5 by way of the carrier element 2** which is now arranged in the work region 5 than by way of the carrier element 2* which was previously arranged there.

In particular, an avoidance position can also be provided between the work region 5 and the magazine 3, in which avoidance position a movement of a carrier element 2 in the transverse direction Y is made possible. If a carrier element 2 to be exchanged is moved out of the work region 5 initially into this avoidance position, another carrier element 2 can be moved more rapidly into the work region 5 and only when the other carrier element 2 is in the work region 5 can the exchanged carrier element 2 be moved into the magazine.

The exemplary embodiments which are shown in the figures and are explained in conjunction with them serve to explain the invention and do not restrict the latter.

### LIST OF DESIGNATIONS

1 Processing station
2 Carrier element
21 Coupling element
22 Transverse direction running roller
23 Support roller
24 Longitudinal direction running rollers
25 Side support roller
29 Workpiece receiving element
3 Magazine
31 First magazine level
32 Middle magazine level
33 Upper magazine level
34 Provision point
35 Rail arrangement of the further magazine levels (32, 33)
36 Stand for middle and upper magazine level
351 Running surface portion
4 First level
5 Work region
6 First transport apparatus
61 Rail arrangement of the first transport apparatus (6)
62 First drive arrangement
63 Transmission element
631 Driver element of a transmission element (63)
64 Drive of the first drive arrangement (62)
7 Second transport apparatus
71 Rail arrangement of the second transport apparatus (7)
711 Rail pair of the rail arrangement (71)
712 Recess
8 Third transport apparatus
81 Lifting element
82 Lifting element
83 Lifting column
84 Rail of a lifting element (81, 82)
841 Running surface of the rail (84)
842 Opening of a U-profile
843 Outer limb of a U-profile
844 Inner limb of a U-profile
85 Drive arrangement of the third transport apparatus
86 Arm
87 Drive unit of the third transport apparatus
9 Fourth transport apparatus
91 Drive arrangement
911 Drive unit
92 Toothed rack
921 Driver element of a toothed rack (92) of the fourth transport apparatus (9)
922 Rail arrangement of the fourth transport apparatus (9) for guiding a toothed rack (92)
923 Running roller of a toothed rack (92)
11 Coupling position
12 Decoupling position
13 Transport running surface
A Starting position
B Target position
E1 Sectional plane
R Welding robot
X Longitudinal direction
Y Transverse direction
Z Vertical direction
S1 Arrows for symbolically representing the method steps
to
S14

What is claimed is:

1-14. (canceled)

15. A processing station for workpieces which are configured as vehicle body parts, comprising:
a plurality of carrier elements,
a magazine for providing the carrier elements, the magazine comprising a first magazine level in a first level,
a work region for processing workpieces in the first level,
a first transport apparatus for transporting the carrier elements between the work region and a provision point of the magazine in the first magazine level in a longitudinal direction, and
a second transport apparatus for transporting the carrier elements in the magazine in the first magazine level in a transverse direction,
wherein the magazine comprises at least one further magazine level outside the first level,
the processing station comprising a third transport apparatus for transporting the carrier elements in a vertical direction between the magazine levels,
the third transport apparatus having, lying opposite one another, in each case one lifting element which is adjustable in the vertical direction for front-side receiving of the carrier elements,
the lifting elements comprising a fourth transport apparatus for transporting the carrier elements in a magazine level outside the first level in a transverse direction.

16. The processing station as claimed in claim 15, wherein the fourth transport apparatus comprises at least one drive arrangement with a toothed rack which can be moved in the transverse direction, the toothed rack having a driver element for coupling to a coupling element of a respective carrier element, and it being possible by way of a movement of the toothed rack for a coupled carrier element to be transported in a magazine level outside the first level in a transverse direction.

17. The processing station as claimed in claim 16, wherein the driver element and/or the coupling element are/is of adjustable configuration between a coupling position and a decoupling position.

18. The processing station as claimed in claim 16, wherein the at least one drive arrangement of the fourth transport apparatus comprises in each case one drive unit, the drive unit being arranged on the lifting element.

19. The processing station as claimed in claim 16, wherein each of the lifting elements has in each case one drive arrangement of the fourth transport apparatus.

20. The processing station as claimed in claim 15, wherein the further magazine levels of the magazine comprise in each case one rail arrangement with running surface portions which run in the transverse direction, and the lifting elements comprise in each case one rail with a running surface which runs in the transverse direction, the rail of a lifting element and the rail arrangement of the further magazine levels being adapted to one another in such a way that the rails of the lifting elements which are arranged on a magazine level form, with the rail arrangement of this magazine level, a continuous transport running surface which runs in the transverse direction.

21. The processing station as claimed in claim 20, wherein the carrier elements comprise transverse direction running rollers which are arranged on the front side with in each case a rotational axis which extends in the longitudinal direction, it being possible for the carrier elements to be moved along the transport running surface using the transverse direction running rollers.

22. The processing station as claimed in claim 20, wherein the rail of a respective lifting element is formed by way of a U-profile, the openings of the U-profiles of the lifting elements being arranged so as to lie opposite one another, and the running surfaces of the rails of the lifting elements being formed in each case by way of an inner side of a lower outer limb of the U-profile.

23. The processing station as claimed in claim 22, wherein the carrier elements have support rollers which are arranged on the front side with in each case a rotational axis which extends in the vertical direction, which support rollers are configured to be supported against an inner side of an inner limb of a respective U-profile and, in the case of transport of one of the carrier elements in the transverse direction, to roll in one of the further magazine levels on the inner side of the inner limb.

24. The processing station as claimed in claim 15, wherein the third transport apparatus comprises, lying opposite one another, in each case two lifting columns, between which the respective lifting element can be moved in the vertical direction.

25. The processing station as claimed in claim 15, wherein the first transport apparatus has a rail arrangement for guiding and supporting the carrier elements and at least one first drive arrangement, with two transmission elements which are oriented parallel to the rail arrangement of the first transport apparatus, it being possible for the transmission elements to be coupled independently of one another to the respective carrier element to be transported, in order to move the carrier element in a coupled state in the longitudinal direction.

26. The processing station as claimed in claim 15, wherein the second transport apparatus comprises a rail arrangement, the rail arrangement having rail pairs which are adjustable in the transverse direction for the transport of the carrier elements, the rail pairs being formed from U-profiles, the openings of which lie opposite one another, the carrier elements comprising longitudinal direction running rollers which are arranged on both sides with in each case a rotational axis which extends in the transverse direction, it being possible for the carrier elements to be moved using the longitudinal direction running rollers in the longitudinal direction, the longitudinal direction running rollers rolling within the U-profile during the transport of one of the carrier elements into the provision point or out of the provision point, the U-profiles having, on their upper outer limb, in each case recesses which are arranged above the longitudinal direction running rollers of one of the carrier elements when this carrier element is situated at the provision point.

27. A method for transporting a carrier element from a starting position in a magazine of a processing station into a work region of the processing station, the processing station being configured as claimed in claim 15, and the carrier elements supporting clamping frames which are of different configuration, the carrier element to be transported being arranged, as starting position, in a magazine level outside the first level outside the third transport apparatus, the method comprising:
moving the lifting elements, using the third transport apparatus, to the magazine level, in which the carrier element to be transported is arranged;
transporting the carrier element to be transported, using the fourth transport apparatus, in the transverse direction until the carrier element to be transported is arranged on the front side in the lifting elements;
transporting the carrier element to be transported in the vertical direction into the provision point in the first level, using the third transport apparatus, by way of a vertical movement of the lifting elements;
transporting the carrier element to be transported from the provision point in the transverse direction out of the provision point, using the second transport apparatus;
moving the lifting elements, using the third transport apparatus, in the vertical direction into a magazine level outside the first level;
transporting the carrier element to be transported, using the second transport apparatus, in the transverse direction into the provision point; and
transporting the carrier element to be transported, using the first transport apparatus, in the longitudinal direction from the provision point into the work region.

28. A method for transporting a carrier element from a work region of a processing station into a target position in a magazine of the processing station, the processing station being configured as claimed in claim 15, and the carrier elements supporting clamping frames of different configuration, the carrier element to be transported configured to be arranged as target position in a magazine level outside the first level outside the third transport apparatus, the method comprising:
moving the lifting elements, using the third transport apparatus, in the vertical direction into a magazine level outside the first level;
transporting the carrier element to be transported, using the first transport apparatus, in the longitudinal direction from the work region into the provision point;
transporting the carrier element to be transported, using the second transport apparatus, from the provision point in the transverse direction out of the provision point;
moving the lifting elements to the first magazine level, using the third transport apparatus;
transporting the carrier element to be transported, using the second transport apparatus, in the transverse direction into the provision point until the carrier element to be transported is arranged on the front side in the lifting elements;
transporting the carrier element to be transported in the vertical direction from the provision point into the further level, in which the target position is situated, using the third transport apparatus by way of vertical movement of the lifting elements; and
transporting the carrier element to be transported, using the fourth transport apparatus in the transverse direction into the target position.
